(19) United States
(12) Patent Application Publication
(10) Pub. No.: US 2015/0255854 A1
(43) Pub. Date: Sep. 10, 2015

(54) MOBILE DEVICE AND ANTENNA ELEMENT THEREIN

(71) Applicant: Quanta Computer Inc., Kuei Shan Hsiang (TW)

(72) Inventors: Chun-I Lin, Kuei Shan Hsiang (TW); Hui Lin, Kuei Shan Hsiang (TW); Ming-Che Chan, Kuei Shan Hsiang (TW)

(73) Assignee: Quanta Computer Inc., Kuei Shan Hsiang (TW)

(21) Appl. No.: 14/271,843

(22) Filed: May 7, 2014

(30) Foreign Application Priority Data
Mar. 5, 2014 (TW) 103107360

(51) Int. Cl. H01Q 1/24

(52) U.S. Cl. CPC H01Q 1/243

(57) ABSTRACT

A mobile device includes an antenna element and a metal frame. A first separating gap and a second separating gap are formed on the metal frame. The metal frame includes a float portion. The float portion of the metal frame is positioned between the first separating gap and the second separating gap. The antenna element is disposed adjacent to the float portion of the metal frame. The float portion of the metal frame is configured to direct radiation of the antenna element outwardly.

### CROSS REFERENCE TO RELATED APPLICATIONS

This Application claims priority of Taiwan Patent Application No. 103107360 filed on Mar. 5, 2014, the entirety of which is incorporated by reference herein.

### BACKGROUND OF THE INVENTION

1. Field of the Invention

The disclosure generally relates to a mobile device, and more particularly to a mobile device with a metal frame for enhancement of antenna radiation performance.

2. Description of the Related Art

With the progress of mobile communication technology, portable devices, such as notebook computers, tablet computers, mobile phones, multimedia players, and other hybrid functional portable devices, have become more common To satisfy the demand of users, portable devices usually can perform wireless communication functions. Some devices cover a large wireless communication area; for example, mobile phones use 2G, 3G, LTE (Long Term Evolution) and 4G systems and use frequency bands of 700 MHz, 850 MHz, 900MHz, 1800 MHz, 1900 MHz, 2100 MHz, 2300 MHz, and 2500 MHz. Some devices cover a small wireless communication area; for example, mobile phones use Wi-Fi, Bluetooth, and WiMAX (Worldwide Interoperability for Microwave Access) systems and use frequency bands of 2.4 GHz, 3.5 GHz, 5.2 GHz, and 5.8 GHz.

Current designers often dispose some decorative metal elements on the surfaces of mobile devices to embellish the appearance of mobile devices. However, these decorative metal elements may negatively affect antenna elements which are built in to mobile devices for wireless communication, and they may further degrade communication quality of mobile devices.

### BRIEF SUMMARY OF THE INVENTION

In a preferred embodiment, the invention is directed to a mobile device including a first antenna element and a metal frame. A first separating gap and a second separating gap are formed on the metal frame. The metal frame includes a first float portion. The first float portion is positioned between the first separating gap and the second separating gap. The first antenna element is disposed adjacent to the first float portion.

### BRIEF DESCRIPTION OF DRAWINGS

The invention can be more fully understood by reading the subsequent detailed description and examples with references made to the accompanying drawings, wherein:

FIG. 1 is a diagram illustrating a mobile device according to an embodiment of the invention;

FIG. 2 is a diagram illustrating a mobile device according to an embodiment of the invention;

FIG. 3 is a diagram illustrating a first antenna element according to an embodiment of the invention;

FIG. 4 is a diagram illustrating a first antenna element according to an embodiment of the invention;

FIG. 5 is a diagram illustrating a second antenna element according to an embodiment of the invention;

FIG. 6 is a diagram illustrating return loss of a second antenna element when a metal frame does not have any separating gap, according to an embodiment of the invention; and

FIG. 7 is a diagram illustrating return loss of a second antenna element when a metal frame includes separating gaps, according to an embodiment of the invention.

### DETAILED DESCRIPTION OF THE INVENTION

In order to illustrate the purposes, features and advantages of the invention, the embodiments and figures of the invention are shown in detail as follows.

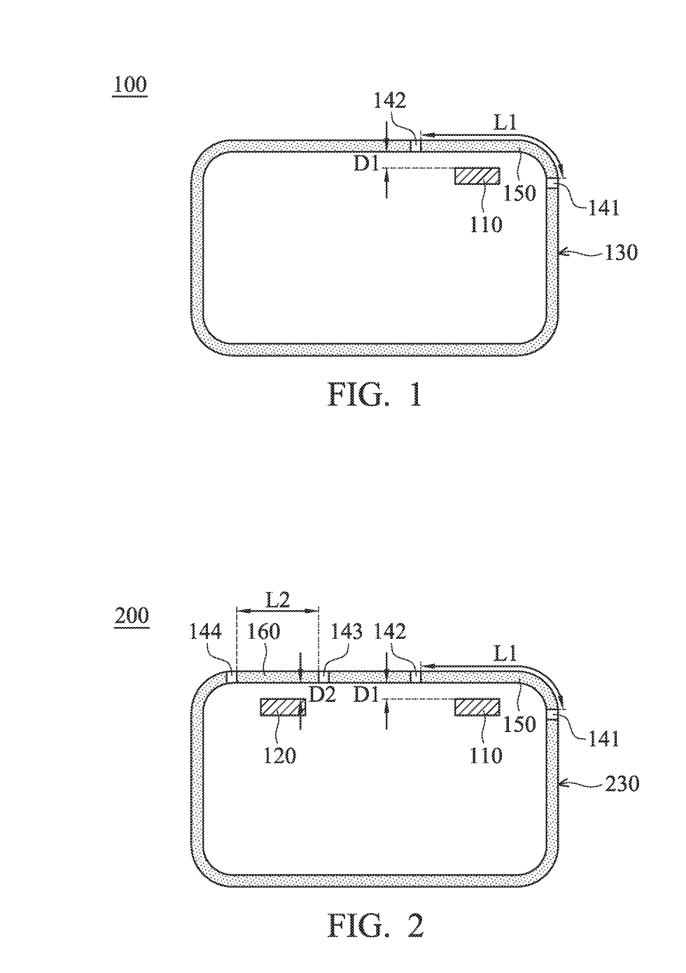

FIG. 1 is a diagram illustrating a mobile device 100 according to an embodiment of the invention. The mobile device 100 may be a smartphone, a tablet computer, or a notebook computer. As shown in FIG. 1, the mobile device 100 at least includes a first antenna element 110 and a metal frame 130. The type of the first antenna element 110 is not limited in the invention. For example, the first antenna element 110 may be a monopole antenna, a dipole antenna, a loop antenna, a patch antenna, or a chip antenna. The metal frame 130 may be formed on a housing (not shown) of the mobile device 100, such as an upper cover of a notebook computer. The metal frame 130 is used as a metal decorative element of the mobile device 100, so as to embellish the appearance of the mobile device 100. It should be understood that the mobile device 100 may further include other components, such as a display device, a wireless communication module, a battery, a processor, and a storage device (not shown).

The metal frame 130 at least includes a first float portion 150. The first antenna element 110 is disposed adjacent to the first float portion 150 of the metal frame 130. In some embodiments, the spacing D1 between the first antenna element 110 and the first float portion 150 is from about 2 mm to about 3 mm. More particularly, a first separating gap 141 and a second separating gap 142 are formed on the metal frame 130, and the first float portion 150 of the metal frame 130 is positioned between the first separating gap 141 and the second separating gap 142. The first separating gap 141 and the second separating gap 142 are arranged to completely isolate the first float portion 150 of the metal frame 130 from the other portions of the metal frame 130. When the first antenna element 110 generates radiation, the first float portion 150 of the metal frame 130 is excited by the first antenna element 110 by mutual coupling, and the first float portion 150 of the metal frame 130 directs the radiation energy of the first antenna element 110 outwardly. In some embodiments, the length L1 of the first float portion 150 of the metal frame 130 is substantially equal to 0.25 wavelength (λ/4) of a central operating frequency of the first antenna element 110. In other embodiments, the length L1 of the first float portion 150 of the metal frame 130 is substantially equal to 0.5 wavelength (λ/2) of the central operating frequency of the first antenna element 110. That is, when the first float portion 150 of the metal frame 130 has a proper resonant length L1, it can be excited to generate the largest induced current, so as to enhance the radiation performance of the first antenna element 110.

In the invention, since the first float portion 150 of the metal frame 130 is electrically isolated from the other portions of the metal frame 130 (i.e., the first float portion 150 can be considered as a non-grounded structure), the first float portion 150 of the metal frame 130 will not shield the radiation from the first antenna element 110 relatively. On the contrary, the first float portion 150 of the metal frame 130 can generate an induced current due to excitation of the first antenna element 110, and therefore the first float portion 150 of the metal frame 130 may be considered as an extension portion (or a parasitic element) of the first antenna element 110. With such a design, the first float portion 150 of the metal frame 130 can direct the radiation energy of the first antenna element to progress outwardly, thereby increasing the antenna efficiency of the first antenna element 110. In comparison to the prior art, the invention has the advantages of both improving the appearance of the mobile device and enhancing the antenna radiation performance thereof, and it is suitable for application in a variety of wireless communication products.

FIG. 2 is a diagram illustrating a mobile device 200 according to an embodiment of the invention. FIG. 2 is similar to FIG. 1. In the embodiment of FIG. 2, the mobile device 200 further includes a second antenna element 120, and a metal frame 230 of the mobile device 200 further includes a second float portion 160. The type of the second antenna element 120 is not limited in the invention. The second antenna element 120 is disposed adjacent to the second float portion 160 of the metal frame 230. In some embodiments, the spacing D2 between the second antenna element 120 and the second float portion 160 is from about 2 mm to about 3 mm. More particularly, a third separating gap 143 and a fourth separating gap 144 are formed on the metal frame 230, and the second float portion 160 of the metal frame 230 is positioned between the third separating gap 143 and the fourth separating gap 144. The third separating gap 143 and the fourth separating gap 144 are arranged to completely isolate the second float portion 160 of the metal frame 230 from the other portions of the metal frame 230. When the second antenna element 120 generates radiation, the second float portion 160 of the metal frame 230 is excited by the second antenna element 120 by mutual coupling, and the second float portion 160 of the metal frame 230 directs the radiation energy of the second antenna element 120 outwardly. In some embodiments, the length L2 of the second float portion 160 of the metal frame 230 is substantially equal to 0.25 wavelength (λ/4) of a central operating frequency of the second antenna element 120. In other embodiments, the length L2 of the second float portion 160 of the metal frame 230 is substantially equal to 0.5 wavelength (λ/2) of the central operating frequency of the second antenna element 120. That is, when the second float portion 160 of the metal frame 230 has a proper resonant length L2, it can be excited to generate the largest induced current, so as to enhance the radiation performance of the second antenna element 120. It is noted that when the second antenna element 120 and the first antenna element 110 are very close to each other, the third separating gap 143 may overlap with the second separating gap 142, so as to form one consolidated separating gap. Other features of the mobile device 200 of FIG. 2 are similar to those of the mobile device 100 of FIG. 1. Therefore, the two embodiments can achieve similar levels of performance.

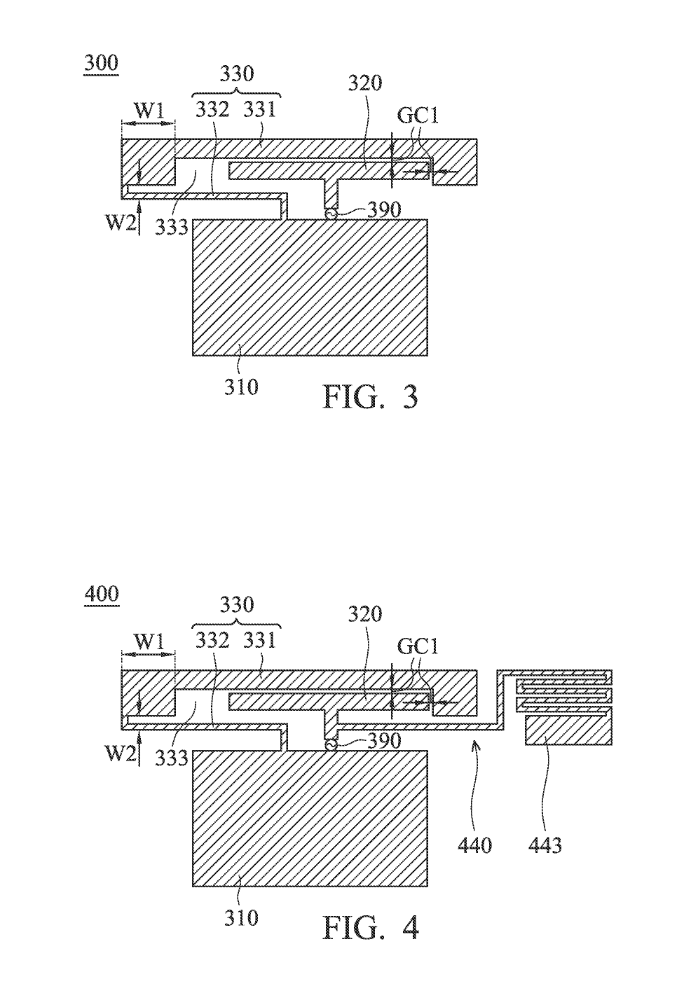

The following embodiments of FIGS. 3, 4, and 5 are further presented to describe detailed features of the aforementioned first and second antenna elements 110 and 120. It should be understood that these detailed features are just exemplary, not limitations of the invention.

FIG. 3 is a diagram illustrating a first antenna element 300 according to an embodiment of the invention. The first antenna element 300 can cover a first communication band and a second communication band. For example, the first communication band may be from about 700 MHz to about 960 MHz, and the second communication band may be from about 1710 MHz to about 2690 MHz. In the embodiment of FIG. 3, the first antenna element 300 at least includes a ground plane 310, a feeding element 320, and a coupling radiation element 330. The ground plane 310, the feeding element 320, and the coupling radiation element 330 may be all made of metal, such as copper, silver, iron, aluminum, or their alloys. In some embodiments, the first antenna element 300 is disposed on a dielectric substrate, such as an FR4 (Flame Retardant 4) substrate. The ground plane 310 may be coupled to a system ground plane of the mobile device 200, or may be a portion of the system ground plane. The feeding element 320 substantially has a T-shape. The feeding element 320 is coupled to a first signal source 390. The first signal source 390 may be a wireless communication module of the mobile device 200, and may be configured to excite the first antenna element 300. The coupling radiation element 330 is coupled to the ground plane 310. The coupling radiation element 330 is separate from the feeding element 320 and is disposed adjacent to the feeding element 320. To save design space, the coupling radiation element 330 at least partially surrounds the feeding element 320.

More particularly, in some embodiments, the coupling radiation element 330 includes a main portion 331 and a shorting portion 332. The main portion 331 is disposed adjacent to the feeding element 320. The main portion 331 is coupled through the shorting portion 332 to the ground plane 310. In some embodiments, the coupling radiation element 330 has a width-varying structure. For example, the width W2 of the shorting portion 332 is much narrower than the width W1 of the main portion 331. The width-varying structure is configured to adjust the impedance matching of the first antenna element 300. In other embodiments, adjustments are made such that the coupling radiation element 330 has an equal-width structure. A coupling gap GC1 may be formed between the feeding element 320 and the main portion 331 of the coupling radiation element 330, and therefore the feeding energy of the first signal source 390 may be transmitted from the feeding element 320 through the coupling gap GC1 to the coupling radiation element 330. To enhance the mutual coupling effect, the width of the coupling gap GC1 should be less than 2 mm, and may be preferably from about 0.5 mm to about 1 mm. In some embodiments, the main portion 331 of the coupling radiation element 330 substantially has an inverted U-shape. In other words, the main portion 331 of the coupling radiation element 330 has a notch 333, and at least one portion of the feeding element 320 is located in the notch 333. In some embodiments, the notch 333 substantially has a rectangular shape or a rectangular edge. In other embodiments, adjustments are made such that the notch 333 substantially has a semicircular shape or an arc-shaped edge. On the other hand, the shorting portion 332 of the coupling radiation element 330 may have a variety of shapes, such as an N-shape, an L-shape, or an S-shape.

FIG. 4 is a diagram illustrating a first antenna element 400 according to an embodiment of the invention. FIG. 4 is similar to FIG. 3. The difference between the two embodiments is that the first antenna element 400 of FIG. 4 further includes an extension radiation element 440. The extension radiation element 440 may be made of metal, such as copper, silver, iron, aluminum, or their alloys. The extension radiation element 440 is coupled to the feeding element 320. In some embodiments, a connection end of the extension radiation element 440 is adjacent to a feeding end of the feeding element 320. To increase the resonant length and reduce the area, the extension radiation element 440 may have a meander structure. In some embodiments, the extension radiation element 440 further includes a rectangular widening portion 443. More particularly, a connection end of the extension radiation element 440 is coupled to the feeding element 320 (e.g., the connection end is adjacent to a feeding end of the feeding element 320), and the rectangular widening portion 443 is located at another end (opposite to the connection end) of the extension radiation element 440. The rectangular widening portion 443 of the extension radiation element 440 provides a capacitive load, and the capacitive load is used to adjust the impedance matching of the first antenna element 400 and to further increase the bandwidth of the first antenna element 400. In other embodiments, adjustments are made such that the rectangular widening portion 443 of the extension radiation element 440 substantially has a square shape or a semicircular shape. Other features of the first antenna element 400 of FIG. 4 are similar to those of the first antenna element 300 of FIG. 3. Therefore, the two embodiments can achieve similar levels of performance.

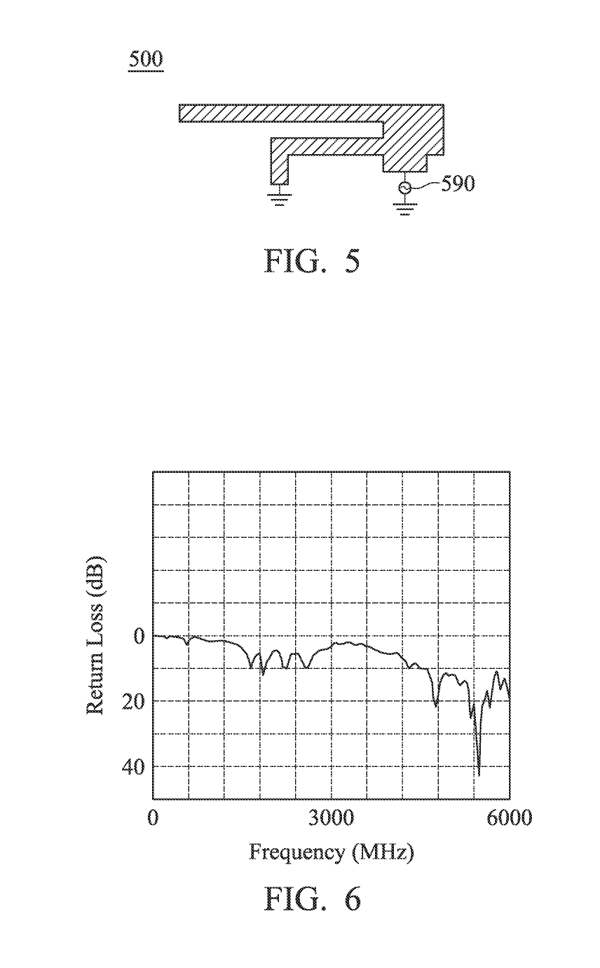

FIG. 5 is a diagram illustrating a second antenna element 500 according to an embodiment of the invention. The second antenna element 500 can cover a third communication band and a fourth communication band. For example, the third communication band may be from about 2400 MHz to about 2484 MHz, and the fourth communication band may be from about 5150 MHz to about 5850 MHz. In the embodiment of FIG. 5, the second antenna element 500 is a PIFA (Planar Inverted F Antenna), and it is excited by a second signal source 590.

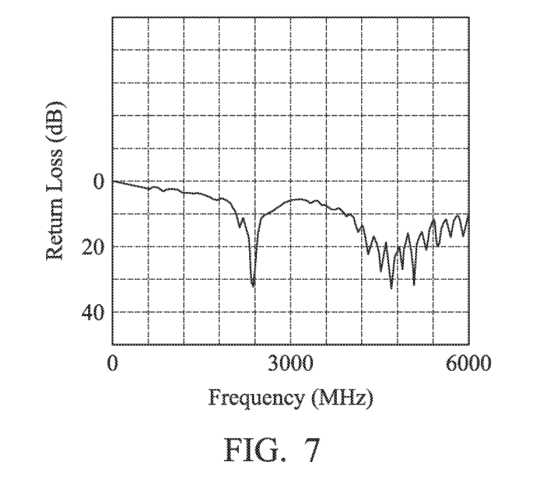

In order to further illustrate the effect of the invention for improvement of the antenna radiation performance, the following embodiments of FIGS. 6 and 7 describe the different radiation efficiency of the second antenna element 120 with the metal frame 230 having or not having the separating gaps. It should be understood that the improvement of the first antenna element 110 is similar to that of the second antenna element 120, and the inventive effect thereof will not be described again.

FIG. 6 is a diagram illustrating return loss of the second antenna element 120 when the metal frame 230 does not have any separating gap, according to an embodiment of the invention. The horizontal axis represents operating frequency (MHz), and the vertical axis represents return loss (dB). According to the measurement of FIG. 6, when the metal frame 230 is a complete loop without any separating gap, the metal frame 230 tends to shield the radiation of the second antenna element 120, and therefore the second antenna element 120 has poor impedance matching in low-frequency bands (e.g., from about 2400 MHz to about 2484 MHz).

FIG. 7 is a diagram illustrating return loss of the second antenna element 120 when the metal frame 230 includes the third separating gap 143 and the fourth separating gap 144, according to an embodiment of the invention. The horizontal axis represents operating frequency (MHz), and the vertical axis represents return loss (dB). According to the measurement of FIG. 7, when the second float portion 160 of the metal frame 230 is completely isolated by the third separating gap 143 and the fourth separating gap 144, the second float portion 160 tends to generate induced currents due to the excitation of the second antenna element 120. In this case, the metal frame 230 may be considered as an extension portion (e.g., a parasitic element) of the second antenna element 120, and it does not result in the shielding effect and can effectively improve the radiation performance of the second antenna element 120. According to some measurements, after at least one portion of the metal frame 230 is modified to be a float design, the antenna efficiency of the second antenna element 120 may be enhanced by about +5% to +10% in every band.

Note that the above element parameters, element shapes, and frequency ranges are not limitations of the invention. An antenna engineer can adjust these settings or values according to different requirements. It is understood that the mobile device and antenna structure of the invention are not limited to the configurations of FIGS. 1-7. The invention may merely include any one or more features of any one or more embodiments of FIGS. 1-7. In other words, not all of the features shown in the figures should be implemented in the mobile device and antenna structure of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A mobile device, comprising:
a first antenna element; and
a metal frame, wherein a first separating gap and a second separating gap are formed on the metal frame, the metal frame comprises a first float portion, the first float portion is positioned between the first separating gap and the second separating gap, and the first antenna element is disposed adjacent to the first float portion.

2. The mobile device as claimed in claim 1, wherein the first float portion is excited by the first antenna element, and the first float portion is configured to direct radiation energy of the first antenna element outwardly.

3. The mobile device as claimed in claim 1, wherein a length of the first float portion is substantially equal to 0.25 wavelength of a central operating frequency of the first antenna element.

4. The mobile device as claimed in claim 1, wherein the first antenna element comprises:
a ground plane;
a feeding element, coupled to a first signal source, wherein the feeding element substantially has a T-shape; and
a coupling radiation element, coupled to the ground plane, and disposed adjacent to the feeding element, wherein the coupling radiation element is separate from the feeding element and at least partially surrounds the feeding element.

5. The mobile device as claimed in claim 4, wherein the coupling radiation element comprises a main portion and a shorting portion, the main portion is disposed adjacent to the feeding element and is coupled through the shorting portion to the ground plane, the main portion substantially has an inverted U-shape, the coupling radiation element has a width-varying structure, and a width of the shorting portion is much narrower than a width of the main portion.

6. The mobile device as claimed in claim 4, wherein the first antenna element further comprises:
an extension radiation element, coupled to the feeding element, wherein the extension radiation element has a meander structure, the extension radiation element further comprises a rectangular widening portion, one end of the extension radiation element is coupled to the feeding element, and the rectangular widening portion is located at another end of the extension radiation element.

7. The mobile device as claimed in claim 1, further comprising:
a second antenna element, wherein a third separating gap and a fourth separating gap are further formed on the metal frame, the metal frame further comprises a second float portion, the second float portion is positioned between the third separating gap and the fourth separating gap, and the second antenna element is disposed adjacent to the second float portion.

8. The mobile device as claimed in claim 7, wherein the second float portion is excited by the second antenna element, and the second float portion is configured to direct radiation energy of the second antenna element outwardly.

9. The mobile device as claimed in claim 7, wherein a length of the second float portion is substantially equal to 0.25 wavelength of a central operating frequency of the second antenna element.

10. The mobile device as claimed in claim 7, wherein the second antenna element is a PIFA (Planar Inverted F Antenna) coupled to a second signal source.
